(19) United States
(12) Patent Application Publication
(10) Pub. No.: US 2011/0263031 A1
(43) Pub. Date: Oct. 27, 2011

(54) Process, Portable Equipment and Device for In Vitro, One-Step Photometric Determination of Hemoglobin Concentration in a Diluted Blood Sample

(76) Inventors: Paulo Alberto Paes Gomes, Sao Paulo (BR); Mauricio Marques de Oliveira, Sao Paulo (BR); Jair Ribeiro Chagas, Sao Paulo (BR)

(21) Appl. No.: 12/937,873

(22) PCT Filed: Nov. 28, 2008
(86) PCT No.: PCT/BR2008/000360

§ 371 Date: Feb. 16, 2011

(30) Foreign Application Priority Data
Apr. 17, 2008 (BR) PI0802336-0

(51) Int. Cl. G01N 21/75

(52) U.S. Cl. 436/66; 422/82.05

(57) ABSTRACT

A process, portable equipment and device for in vitro photometric determination of hemoglobin concentration in diluted blood. The present invention allows its use in field anemias prospection programs. The present invention has a light source (1) whose wavelength is between 500 and 550 nm, a cylindrical sample holder (3), whose diameter is between 8 and 20 mm, a photosensor (2) to perform the sample photometry and a microprocessor for automatically starting the light source, acquiring the signal obtained by the photosensor (2), performing the hemoglobin concentration calculations and displaying the results in a liquid crystal display. The device also has a sealed cylindrical bottle, which is simultaneously used as a package for the reagent and as an optical component in the process, allowing photometric reading through its walls.

The present invention relates to a process, portable equipment and device for in vitro photometric determination of hemoglobin concentration in diluted blood.

The use of the present invention is feasible in field anemias prospection.

### INTRODUCTION

Vertebrates, for having very large body masses, have developed a system able to capture oxygen from the atmosphere or liquid medium and distribute it throughout their bodies, as well as to eliminate the main catabolite from aerobic metabolism, carbon dioxide.

The prevailing evolution strategy was the one incorporating an oxygen carrier, the hemoglobin, a molecule with selective affinity for O₂, present inside erythrocytes.

Hemoglobin allows blood to transport 50 times more O₂ than isolated plasma. For having varying affinity for O₂, depending on several physiological factors, it allows oxygen molecules binding and releasing in appropriate sites.

Hemoglobin comprises two protein chains, the globins, and one prosthetic core, the heme, which, on its turn, is composed of two protoporphyrins and one iron molecule.

Anemia may be described as a decrease in the number of circulating erythrocytes, of the hemoglobin content in blood, or both, with several etiologies, also due to nutritional iron deficit (Beutler, 2005).

The scientific community agrees that anemia due to iron deficit is the biggest nutritional problem in the world, affecting all income brackets (Demayer E M, 1989).

In terms of clinical diagnosis, anemia is a difficult-to-detect pathology, as there are no pathognomonic signs allowing an unequivocal diagnosis. The minimum database for the clinician decision-making process shall include information about the oxygen carrying capacity through blood, which is traditionally performed by means of a hemogram.

### STATE-OF-THE-ART DESCRIPTION

Traditional, widely used methodologies for determining oxygen carrying capacity throughout blood are erythrogram, hematocrit and hemoglobin count. In the first two methodologies, measurements are performed, either of erythrocytes number or of their percentage related to total blood volume, composing an indirect estimate of hemoglobin concentration (Beutler, 2005). In the third one, a direct measurement of the molecule responsible for carrying O₂ is performed. Although reliable, these methods require a phlebotomy for venous blood collection and sample processing in laboratory environment, making its use in field anemias prospection impractical.

### Description of Hemoglobinometry Methods

At the beginning of the 20^{th} century, several qualitative and quantitative methods were developed for hemoglobin count, using either the hemoglobin color itself, or the one of a product resulting from its reaction with reagents (Ackerman, P C, 1925; Dare, A, 1922). The disadvantage of these methods was that they were little accurate.

The principles established and used up to now comprise erythrocytes lysis and the release of their hemoglobin content into a solution in which a colored compound is formed by means of chemical reactions, in an amount directly proportional to the hemoglobin content. The traditional method, considered “gold standard” up to the current days, is Cyanmethemoglobin. It comprises the transformation of hemoglobin in a stable compound, under the action of Potassium Cyanide and Potassium Ferricyanide. This compound is, then, measured by means of its light absorption in a certain wavelength (Beutler, 2005).

As these compounds have toxicity, cyanide-free reagents for hemoglobin count have been developed (Zandler, et al, 1982, Benezra, J, 1989; Benezra, J, 1995).

In laboratories, for photometric measurement of Hb concentration with spectrophotometers, 3 different samples are used. The first sample is a known high-transmittance substance, usually deionized water, and is named “Blank”. The second one is a sample with known Hb concentration, usually 10 g/dL, named “Standard”. The third one is the sample of which the Hb concentration is intended to be known, named “Test”.

The values of light intensity on a photosensor are measured, by positioning a cuvette with each one of these samples, between it and a light source. These intensities are named I_{B}, I_{P} and I_{T}. Thereafter, the Standard and the Test Absorbance are calculated, automatically or manually, established as:

Abs(P)=Log10(I_{B}/I_{P})

Abs(T)=Log10(I_{B}/I_{T})

Later, the Hemoglobin concentration is calculated as:

[Hb]=10*Abs(T)/Abs(P) in g/dL

Therefore, three measurements and calculations are required for obtaining the final result for the sample tested, usually in g/dL.

Methodologies alternative to photometry have also been patented, such as an electrochemical assay (Greem, M J, 1989).

Based on electronics progress, such as microprocessors and accurate wavelength LED (Light Emitting Diodes) development, it was possible to automate the procedures, as well as to develop portable equipment (Loretz, T J, 1982; Noller, H G, 1989). That, along with experimental results validating the use of peripheral blood in hemoglobin count, allowed the performance of field anemia research, a great advance in terms of public health (Chen P P, 1992; Paiva A A et al, 2004).

Considering the features of the absorption spectrum of the several hemoglobin types, different wavelengths were used for photometric readings in hemoglobinometry tests, from 500 nm (Pettersson, J, 2004), up to 800 nm (Ziegler, W, 1998; Ziegler, W, 2000).

Worldwide, the few commercial alternatives of portable equipment for field anemias diagnosis are either little accurate methodology or accurate but high-cost systems (Lara A M, 2005).

Several methodologies share the world market, adapted to economical and social development conditions of the several nations (PATH, 1997; Shepherd et al, 2001; Dykes, C, 2004; Pettersson, J, 2004).

Table 1, below, shows a comparative chart between the several technologies for hemoglobinometry.

TABLE 1
Comparison between several hemoglobinometry methods

| | | | ADDITIONAL | | | |
|---|---|---|---|---|---|---|
| METHOD | PRINCIPLE | SAMPLE | EQUIPMENT | ACCURACY | ADVANTAGES | DISADVANTAGES |
| Clinical | mucous | No | light | Sensitivity: | Low cost | Low precision |
| Signs | membranes | | source | 60% (only in | Minimum | Does not |
| | color and | | | cases of | equipment | detect |
| | other | | | severe | | moderate |
| | symptoms | | | anemia). | | anemias |
| | | | | Specificity: | | |
| | | | | 70%-100% | | |
| Filter | comparison | 1 blood | filter | Sensitivity: | Low cost, | Low precision |
| Paper | of the | drop | paper, | 60% | fast, | Lighting |
| | color of a | | comparison | (10 g/dL) | simple, | condition |
| | blood drop | | scale, | Specificity: | portable, | influences |
| | to a | | lancet | 60% | no | the result |
| | standard | | | (10 g/dL) | reagents, | |
| | | | | | no | |
| | | | | | electric | |
| | | | | | power | |
| Copper | comparison | 1 blood | weighing | Sensitivity: | Low cost | Low precision |
| Sulfate | of | drop | scale, | 90% | Visual | Requires pure |
| | specific | | glassware | (10 g/dL) | inter- | reagents, |
| | gravity | | in | | pretation | anticoagulants, |
| | blood × | | general, | | more | CuSO₄ |
| | CuSO₄ | | analytical | | accurate | solutions at |
| | | | CuSO₄•5H₂O, | | than | several |
| | | | distilled | | similar | concentrations |
| | | | water, | | methods | |
| | | | glass | | Does not | |
| | | | capillary | | require | |
| | | | with | | electricity | |
| | | | anticoagulant, | | | |
| | | | lancet | | | |
| Hematocrit/ | Relation | capillary | glass | Sensitivity: | Low cost, | Requires |
| centrifuge | erythrocytes | tube | capillary | 100% | fast, | centrifuge, |
| | volume × | filled | with | (10 g/dL) | simple, | anticoagulants, |
| | total blood | with | anticoagulant, | Specificity: | good | electric |
| | volume | blood | centrifuge, | 60% | accuracy | power |
| | | | reference | (10 g/dL) | | |
| | | | ruler, | | | |
| | | | lancet | | | |
| Comparator | Visual | 50 μl | Comparator | Sensitivity: | Durable | Reasonable |
| Lovibond | comparison | venous | Lovibond, | 60% | equipment, | cost, |
| | of blood | blood | Glass | (10 g/dL) | simple, | requires a |
| | diluted in | | tubes, | Specificity: | fast, | large blood |
| | reagent | | micropipette, | 60% | reasonable | sample |
| | with colors | | reagents | (10 g/dL) | accuracy | |
| | scale | | | | | |
| Photometer | Optical | 5-10 μl | Photometer | Sensitivity: | Low cost, | Low |
| Grey | Wedge | blood | Grey | 77.5% | portable, | precision, |
| Wedge | | | Wedge, | (10 g/dL) | cheap | hard |
| | | | stick | Specificity: | | operation |
| | | | with | 96% | | |
| | | | saponin, | (10 g/dL) | | |
| | | | glass | | | |
| | | | chamber, | | | |
| | | | calibration | | | |
| | | | standard | | | |
| | | | and | | | |
| | | | detergent | | | |
| Sahli | Transformation | 20 μl | Hemoglobinometer | Sensitivity: | Low cost, | Low |
| Method | Hb | blood | and | 85% | does not | precision, |
| | into acid | | Sahli | (10 g/dL) | require | difficult to |
| | Hematin | | pipette, | Specificity: | electric | perform |
| | and visual | | glass | 85% | power | |
| | comparison | | pipette, | (10 g/dL) | | |
| | with | | hydrochloric | | | |
| | standard | | acid | | | |
| | | | 0.1N and | | | |
| | | | detergent | | | |
| Hemocue | portable | 10 μl | Photometer | Sensitivity: | Portable, | High cost of |
| | photometer, | blood | Hemocue, | 85% | accurate, | equipment and |
| | Azida | | disposable | (10 g/dL) | fast and | cuvettes, |
| | method | | cuvettes, | Specificity: | simple | sensitive to |
| | | | standard | 94% | | humidity |
| | | | cuvette, | (10 g/dL) | | after the |
| | | | batteries | | | package is |
| | | | and | | | open, |
| | | | lancets | | | cuvettes last |
| | | | | | | 3 months |
| Cyanmethemoglobin | transformation | 20 μl | Spectrophotometer, | Sensitivity: | Method | Expensive |
| | Hb | blood | cuvettes, | 100% | with | equipment, |
| | into | | pipettes, | (10 g/dL) | higher | are not |
| | Hemoglobin | | standard | Specificity: | accuracy, | portable, |
| | cyanide | | solution, | 100% | stable | requires |
| | and | | Drabkin | (10 g/dL) | samples | electricity, |
| | photometric | | solution, | | | generates |
| | reading | | Lancets | | | toxic |
| | | | | | | residues |
| Ultracrit | Hematocrit | 1 blood | Equipment | Precision ≦0.8% | Good | High cost of |
| | (Hct) | drop | Ultracrit ®, | at 41 | accuracy, | equipment and |
| | determination | | disposable | Hct | fast and | cuvettes, |
| | by | | cuvettes, | Accuracy: ≦0.4% | simple | sensitive to |
| | ultrasound | | reference | Hct | | humidity |
| | | | control, | Linearity: | | |
| | | | lancets | 10.3-72% | | |
| | | | | Hct | | |
| Hemopoint | Portable | 10 μl | Photometer | Precision <1.2% | Good | High cost of |
| H2 | photometer, | blood | Hemopoint | Accuracy: | accuracy, | equipment and |
| | Azida | | H2, | not stated | fast and | cuvettes, |
| | method | | disposable | Linearity: 0-23.5 g/dL | simple | sensitive to |
| | | | cuvettes, | | | humidity |
| | | | lancets | | | |

The measurement methodology used in bench spectrophotometers is complex, and involves several steps, introducing mistakes and requiring highly trained personnel.

A list of documents and publications supporting the description of the state-of-the-art of the patent in question follows:
Ackerman, P C, inventor. Hemoglobinometer. U.S. Pat. No. 1,545,113. 1925, July 7.
Benezra, J et al. inventors; Bayer Corporation, assignee. Cyanide-Free Hemoglobin Reagent. U.S. Pat. No. 5,468,640. 1995, November 21.
Benezra, J et al. inventors; Technicon Instruments Corporation, assignee. Cyanide-Free Hemoglobin Reagent. U.S. Pat. No. 4,853,338. 1989, August 1.
Beutler, E. Et al. (org.). Williams Hematology. 7 ed. London: McGrall-Hill, 2005. 1856 p.
Chen P P, Short T G, Leung D H Y, Oh T E. A clinical evaluation of the HemoCue haemoglobinometer using capillary, venous and arterial samples. Anaesth Intensive Care 1992; 20:497-503.
Dare, A, inventor. Hemoglobinometer and Illuminating Device Therefor. U.S. Pat. No. 1,414,261. 1922, Abr 25.
Demayer E M. Preventing and controlling iron deficiency anaemia through primary health care—a guide for health administrators and programme managers. Geneva: World Health Organization, 1989.
Dykes, C. et al. Inventors. Disposable Fluid Sample Collection Device. United States PCT/US04/036909. 2004, November 5.
Greem, M J et al. inventors; Medisense Inc, assignee. Electrochemical Assay for Hemoglobin. U.S. Pat. No. 4,876,205. 1989, October 24.
Kitawaki et al. inventors. Blood Processing Method, Blood Processing Device, Method of Measuring Hemoglobins and Device for Measuring Hemoglobins. United States Patent US 2005/0014275A1. 2005, January 20.
Lara A M, Mundy C, Kandulu J, Chisuwo L, Bates I. Evaluation and costs of different haemoglobin methods for use in district hospitals in Malawi J. Clin. Pathol. 2005; 58; 56-60.
Loretz, T J, inventor; Buffalo Medical Specialties Mfg, cessiondrio. Blood Diagnostic Spectrophotomether. U.S. Pat. No. 4,357,105. 1982, November 2.
Noller, H G, inventor. Light Emitting Diode Spectrophotometer. U.S. Pat. No. 4,857,735. 1989, August 15.
Paiva A A, Rondó P H C, Silva S S B, Latorre M R D O Comparison between the HemoCue® and an automated counter for measuring hemoglobin. Rev Saúde Publica 2004, 38(4), 585-7.
PATH, Anemia Detection Methods in Low-Resources Settings: A Manual For Health Workers. US Agency for International Development. Washington, USA. 1997.
Pettersson, J & Svensson, J, inventors; Hemocue, AB, assignee. Analysis Method and System Therefor. U.S. Pat. No. 6,831,733. 2004, December 14.
Shalel, S; Streichman, S; Marmur, A. The Mechanism of Hemolysis by Surfactants: Effect of Solution Composition. J. of Coll and Interfac Sci. 252, 66-76, 2002.
Shepherd et al. inventors; Board of Regents, The University of Texas System, assignee. Method and Apparatus for Direct Spectrophotometric Measurements in Unaltered Whole Blood. U.S. Pat. No. 6,262,798. 2001, July 17.
Williamson, A. et al. Inventors. Capillary Microcuvette. World Intellectual Property Organization WO 96/33399. 1996, October 24.
Zander, R et al. inventors. Process and Reagent for Determination of the Hemoglobin Content of Blood. U.S. Pat. No. 4,341,527. 1982, July 27.
Ziegler, W, inventor; AVL Medical Instruments AG, assignee. Method and Apparatus for Optically Determining Total Hemoglobin Concentration. U.S. Pat. No. 6,103,197. 2000, August 15.
Ziegler, W, inventor; AVL Medical Instruments AG, assignee. Method for Optically Determining Total Hemoglobin Concentration. U.S. Pat. No. 5,773,301. 1998, June 30.
Zijlistra, W. G.; Buursma, A.; Van Assendelft, O. W. Visible and Near Infrared Absorption Spectra of Human and Animal Haemoglobin: Determination and Application. 1st ed. Leiden: Brill Ac Publi, 2000. 368 p.

### BRIEF DESCRIPTION OF DRAWINGS

FIG. 1 shows the results of the linearity test for the equipment in the present invention.

FIG. 2A shows a graph containing the results obtained with three types of equipment (A, B and C), concerning commercial standards of hemoglobin with 10 g/dL.

FIG. 2B shows a graph containing the results obtained with three types of equipment (A, B and C), concerning commercial standards of hemoglobin with 5 g/dL.

FIG. 3A shows the linearity of measurements obtained by equipment B developed with commercial standard of hemoglobin at concentrations 0; 2.5; 5; 7.5; 10; 12.5; 15; 17.5; 20; 22.5 and 25 g/dL.

FIG. 3B shows the linearity of measurements obtained by equipment C, object of the present invention, developed with commercial standard of hemoglobin at concentrations 0; 2.5; 5; 7.5; 10; 12.5; 15; 17.5; 20; 22.5 and 25 g/dL.

FIG. 4 shows graphs comparing the percentage deviation of the hemoglobin measurement value in peripheral blood, obtained by portable hemoglobinometers C and B, respectively, with venous blood obtained from the same patient and measured in analyzer A.

FIG. 5 shows graphs comparing hemoglobinometry using alternative lysing solutions with Drabkin solution, in different blood dilutions.

FIG. 6A shows the linearity of the equipment calibrated to work with 3.0 ml of deionized distilled water and the results of linear regression, using hemoglobin commercial standard.

FIG. 6B shows the linearity of the equipment calibrated to work with 3.0 ml of deionized distilled water and the results of linear regression, using Wistar rats blood samples.

FIG. 6 is a block diagram for the program provided in the equipment of the present invention.

FIG. 7 is an exploded perspective view of the equipment of the present invention.

FIG. 8 is an electrical diagram of the equipment of the present invention.

FIG. 9 shows the optical system of the equipment of the present invention.

FIG. 10 shows the sample holder of the present invention.

FIG. 11 shows the cover for the sample holder on FIG. 10.

### OBJECTIVES OF THE INVENTION

The process developed has advantages over the bench equipment, as “blank” and “standard” measurements are not required, and it may be performed as a single step, and additionally, it is different from the solutions provided by other portable equipment.

Table 2 shows the measurements of 10 different samples of a commercial hemoglobin standard with 10 g/dl, in 4 units of the equipment developed.

TABLE 2
Results of measurements of 10 Standard samples

| Sample | 1 | 2 | 3 | 4 |
|---|---|---|---|---|
| 1 | 10.3 | 10.0 | 9.9 | 9.8 |
| 2 | 10.1 | 10.0 | 9.9 | 9.9 |
| 3 | 10.0 | 10.0 | 9.8 | 10.0 |
| 4 | 10.1 | 10.1 | 9.9 | 10.0 |
| 5 | 10.4 | 10.0 | 9.9 | 9.9 |
| 6 | 10.3 | 10.1 | 10.1 | 10.1 |
| 7 | 9.8 | 10.0 | 9.9 | 9.9 |
| 8 | 10.1 | 10.0 | 10.0 | 9.9 |
| 9 | 10.0 | 10.0 | 10.0 | 10.0 |
| 10 | 9.5 | 9.9 | 9.8 | 9.8 |

After a variance analysis, it may be concluded that there is no statistically significant difference between the means (p=0.13358) around 10 g/dL in the 4 pieces of equipment, and it has been concluded that they have performed equivalent measurements.

Based on the data above, we can estimate intra-assay precision and accuracy for each piece of equipment, at 10 g/dL concentration. According to ANVISA [Brazilian Health Authority] Guide for Analytic and Bionalytic Methods Validation, precision may be expressed as the relative standard deviation (RSD) or as a coefficient of variation (CV %):

RSD=100*SD/ACD

Accuracy=100*ACD/TC

Where:

RSD is the Relative Standard Deviation

SD is the Standard Deviation

ACD is the Mean Concentration Determined

TC is the Theoretical Concentration (or Nominal)

For the equipment tested, we obtained:

TABLE 3
Equipment Precision and Accuracy

| | 1 | 2 | 3 | 4 |
|---|---|---|---|---|
| Mean | 10.06 | 10.01 | 9.92 | 9.93 |
| SD | 0.26 | 0.06 | 0.09 | 0.09 |
| RSD | 2.6 | 0.6 | 0.9 | 1.0 |
| Accuracy | 100.6 | 100.1 | 99.2 | 99.3 |

The Linearity Tests for the equipment have been performed using standard solutions in Drabkin reagent as samples, with hemoglobin concentrations equivalent to 2.5; 5.0; 7.5; 10.0; 12.5; 15; 17.5 and 20 g/dL. FIG. 1 shows the results and table 4 shows the linear regression parameters.

TABLE 4
Linear Regression Parameters (Y = aX + b)

| Equipment | a | b | r |
|---|---|---|---|
| 1 | 0.96 | 0.31 | 0.9998 |
| 2 | 0.96 | 0.27 | 0.9998 |
| 3 | 0.97 | 0.22 | 0.9998 |
| 4 | 0.95 | 0.45 | 0.9997 |

A comparison of 10 and 5 g/dL hemoglobin commercial standards measurements has been performed in three pieces of equipment:
Bench hematologic analyzer Celm®, model CC 530/550, considered gold standard (identified as equipment A);
Portable hemoglobinometer Hemocue® 201 (identified as equipment B);
Hemoglobinometer Agabe (identified as equipment C), object of this patent application.

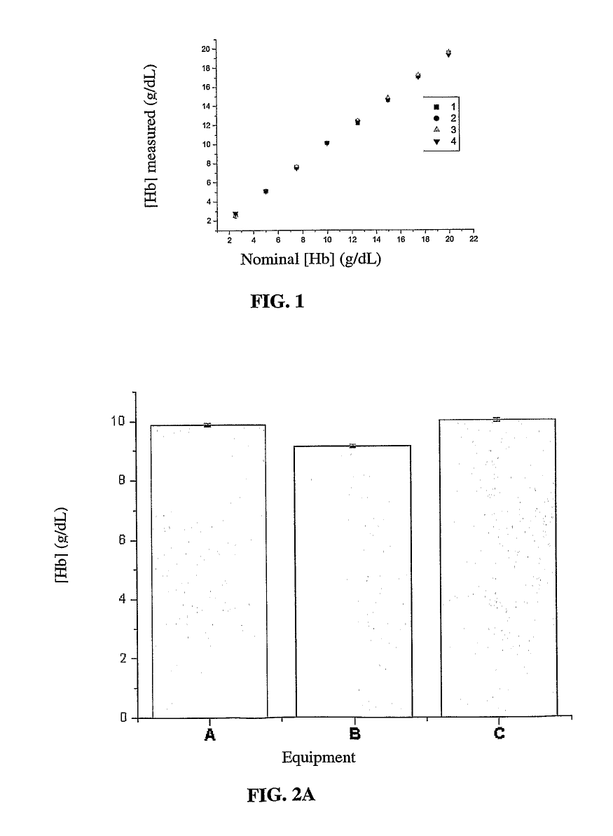

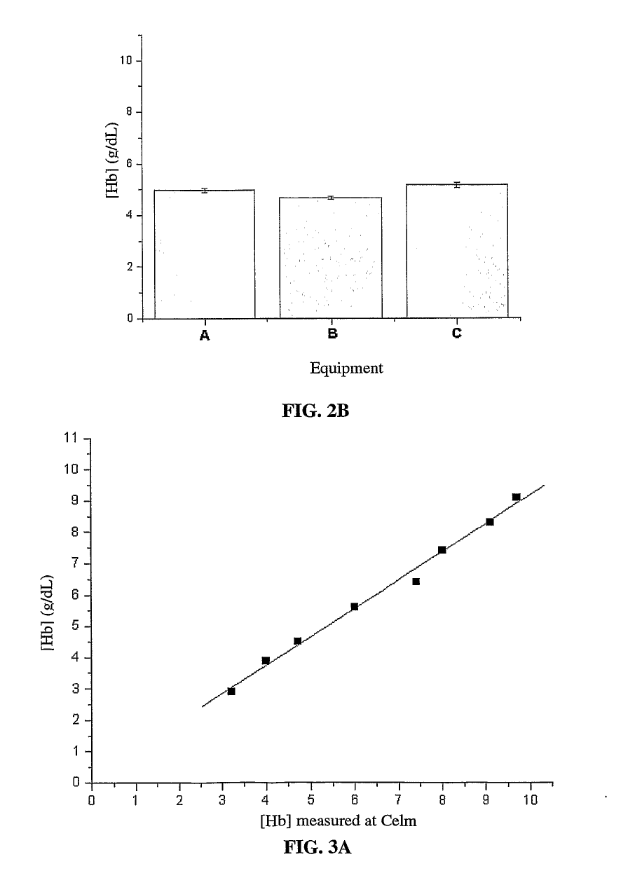

The similar accuracy and precision between the equipment tested may be observed on table 5 and on FIGS. 2A and 2B.

TABLE 5
Comparison between equipment A, B and C
with 10 and 5 g/dL commercial hemoglobin standards.

| | A | B | C |
|---|---|---|---|
| | 10 g/dL | | |
| Mean | 9.88 | 9.15 | 10.01 |
| SD | 0.06 | 0.05 | 0.06 |
| RSD | 0.64 | 0.58 | 0.57 |
| Accuracy | 98.8 | 91.5 | 100.1 |
| | 5 g/dL | | |
| Mean | 4.98 | 4.67 | 5.16 |
| SD | 0.08 | 0.05 | 0.11 |
| RSD | 1.58 | 1.03 | 2.08 |
| Accuracy | 99.6 | 93.4 | 103.2 |

The process in the present invention also has advantages by using an ampoule/cuvette, as it has been a known and efficient filling solution for a long time, associated to a completely novel utilization, as an optical component (cuvette) of the system. This eliminates the step of pipetting the reagent solution, preventing a possible error source, which could influence the final result, and making field performance easier. Table 6 and

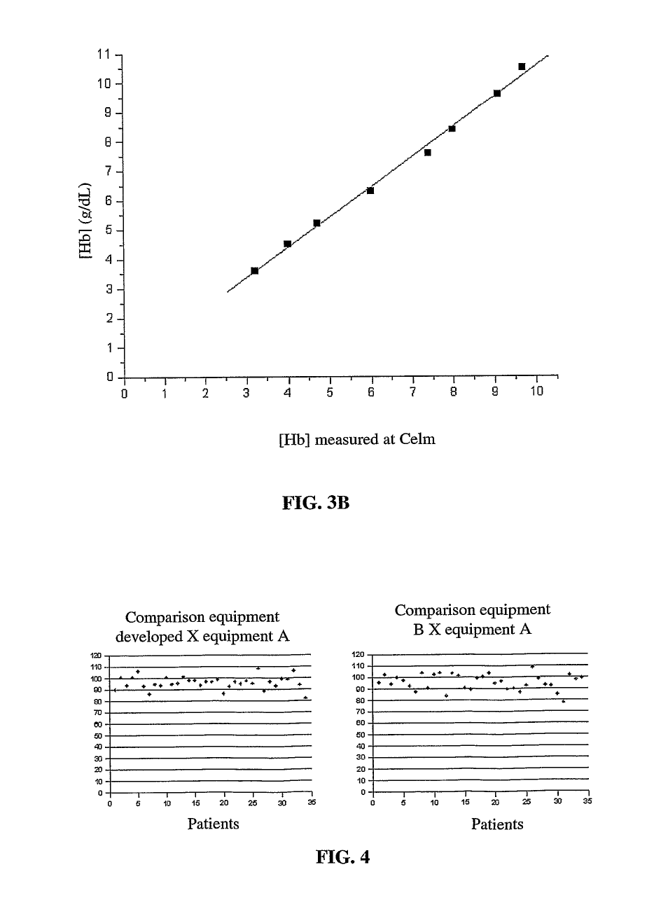

FIG. 3 show the linearity of measurements obtained by the equipment developed with hemoglobin commercial standard, at concentrations 0; 2.5; 5; 7.5; 10; 12.5; 15; 17.5; 20; 22.5 and 25 g/dL.

TABLE 6
Linear Regression Parameters (Y = aX + b)

| | a | b | r |
|---|---|---|---|
| Equipment B | 0.9 | 0.13 | 0.9958 |
| Equipment C | 1.02 | 0.29 | 0.9977 |

FIG. 4 shows a comparison of hemoglobinometries performed with 3 blood samples from the same patient, two of them being peripheral blood, analyzed in the equipment developed (C) and in the hemoglobinometer B; and another one, venous blood, analyzed by Hematologic analyzer A. The graphs represent the percentage deviation of results obtained with both portable pieces of equipment (B and C), when compared to the bench equipment (A), considered as reference.

The proposed process is innovative by allowing both the use of Modified Drabkin Solution and the use of several lysying solutions, such as deionized distilled water, sodium n-dodecyl sulfate at 0.5% (SDS), Urea at 1% and Urea 1% in physiological solution, with satisfying results when compared to the gold standard, the cyanmethemoglobin method (FIG. 5).

Alternative lysying solutions (Zijlistra, 2000), which have cost, stability to photodegradation and environmental conditions advantages, additionally to reduction of environmental and toxicological risks, may be used in the equipment developed.

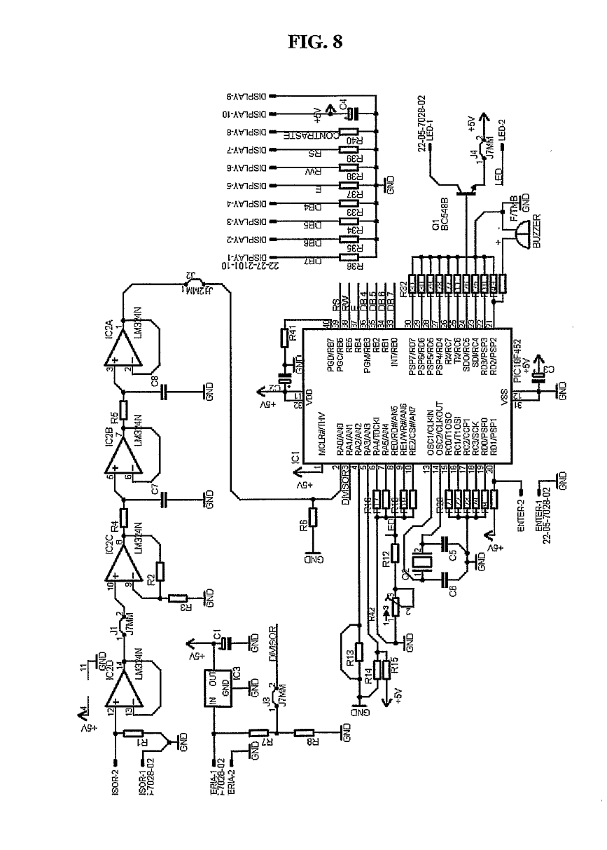

Distilled water is the option with less environmental and occupational impact, and shall be used at a ratio 300:1, for the erythocytes lysis to be complete. On FIG. 8A it is possible to observe the linearity curve for the equipment developed using hemoglobin commercial standard dilutions (2.5; 5; 7.5; 10; 12.5; 15; 17.5; 20; 22.5 e 25 g/dL) in water and in Drabkin liquid. FIG. 8B shows the linearity of the tests performed with Wistar strain rats blood dilutions in water and in Drabkin liquid.

Bench spectrophotomers are fragile and high-cost equipment, which, in addition to low portability, prevent their field use, in anemias prospection campaigns. The equipment developed has robustness, portability and operation simplicity compatible with its field utilization.

Other portable equipment have efficient solutions, however, their projects are highly sophisticated. Our solution integrates electronic components, mechanical parts and a microprocessor in the form of a photometer with fixed wavelength, designed in such a way to allow simplified and low-cost production.

Some portable equipment are associated to sample collection, chemical reaction and photometric reading devices, the microcuvettes (Williamson, 1996; Kitawaki, 2005). It is an efficient solution, however, with high cost and short expiration date when the packaging is opened.

Although the use of ampoules is the state-of-the-art in terms of medications filling, its use is unprecedent as an optical component or cuvette. Thanks to the design of the support developed in the equipment, interferences due both to spurious light and light beam distortions caused by the curved geometry of the ampoule walls have been reduced, in such a way not to influence the reading result. The cylindrical geometry chosen has advantages in industrial terms, making easier and reducing the production cost, both for the samples holder and for the ampoule/cuvette.

### DETAILED DESCRIPTION OF THE INVENTION

At first, the program provided in the software performs several checkings, such as: battery voltage, signal in the dark (LED off) and the analogical electronic output with the LED on.

If all measurements are within the specified ranges, the program prompts the user to position the ampoule-cuvette having the test sample in the holder, and press enter. The acquired signal is then processed and the calculations are made. The result is shown on the liquid crystal display. If the user wishes to continue performing tests, he has only to press enter again and the program returns to the second block.

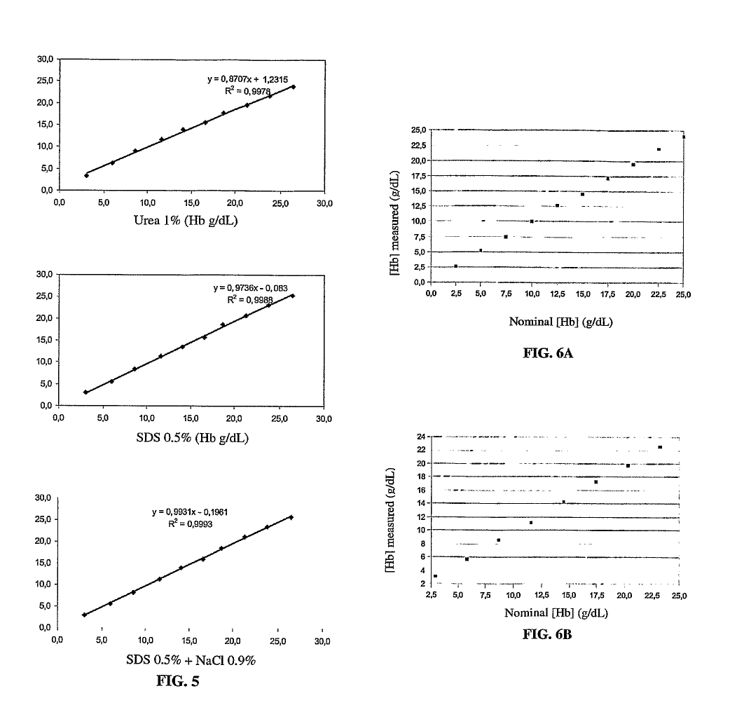

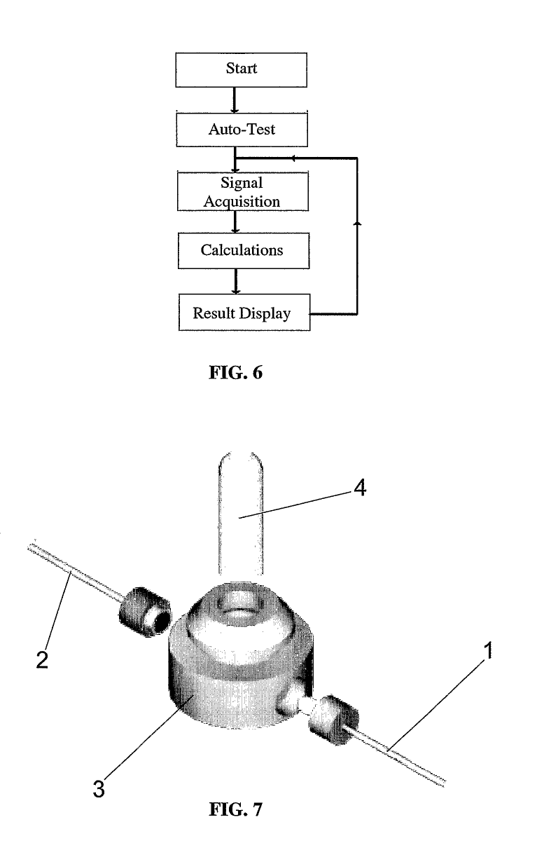

The program saved in the PIC microprocessor may be better understood by analyzing the block diagram on FIG. 6.

The following process was created to obtain the hemoglobin concentration value in one sample:

At first we performed the measurement of light intensity on the sensor with an empty cuvettes holder. We named this intensity We We defined a new absorbance function named Ab, which uses Iₒₙ value as reference, i.e., Ab (X) is equivalent to Log 10 (Iₒₙ/IX). By performing intensity measurements for samples Blank (I_{b}) Standard (I_{P}) and Test (I_{T}), and by calculating Ab for all these samples, we could obtain the hemoglobin concentration value as 10*{Ab(T)−Ab(B)}/{Ab(P)−Ab(B)}. Ab(B) and Ab(P) shall not change with time, even if the intensity of the light emitted by the LED varies. Then, we can experimentally measure the value of these constants by using several Blank and Standard samples, and introduce the mean of these values as constants in the calculation, Ab(B) as C1 and [Ab(P)−Ab(B)] as C2. Thus, we may calculate [Hb] by measuring simply Iₒₙ values, which is made automatically, and I_{T}, which is made by inserting the cuvette containing the sample and pressing only one key. The hemoglobin concentration in the sample is then calculated as 10*[Ab(T)−C1]/C2.

The photometric reading is performed between 500 and 550 nm; preferably between 520 and 540 nm, and more preferably, at 525 nm. In the reading range the analysis is performed, the molar absorbability features of the several hemoglobin variants are similar, allowing readings accurate and precise enough to be made.

As reagent and sample diluter, we may use in the process any lysying solution that does not affect the hemoglobin absorption profile, including Drabkin solution, previously filled in the ampoule/cuvette.

The equipment, shown on FIG. 7, comprises a light source (1) (LED with wavelength between 500 nm and 550 nm), a silicon photosensor (2), a sample holder (3), an analogical electronic circuit (FIG. 8) for enhancing and filtering the sensor signal, and a microprocessor for performing auto-testing, LED lighting, calculations and control of a liquid crystal display. The components are arranged in a polymer packing box.

The LED is mounted on a LED holder (1) and the sensor is mounted on a sensor holder (2), and the imaginary line connecting them horizontally goes through the sample holder center (3), in which the cylindrical ampoule-cuvette (4) is introduced, which is simultaneously a bottle for reagent filling and optical component (cuvette).

The light source (1) wavelength is preferably between 520 and 540 nm, and more preferably, at 525 nm.

The cylindrical sample holder (3) diameter is between 8 and 20 mm, preferably between 10 and 14 mm, and more preferably, at 12.9 mm.

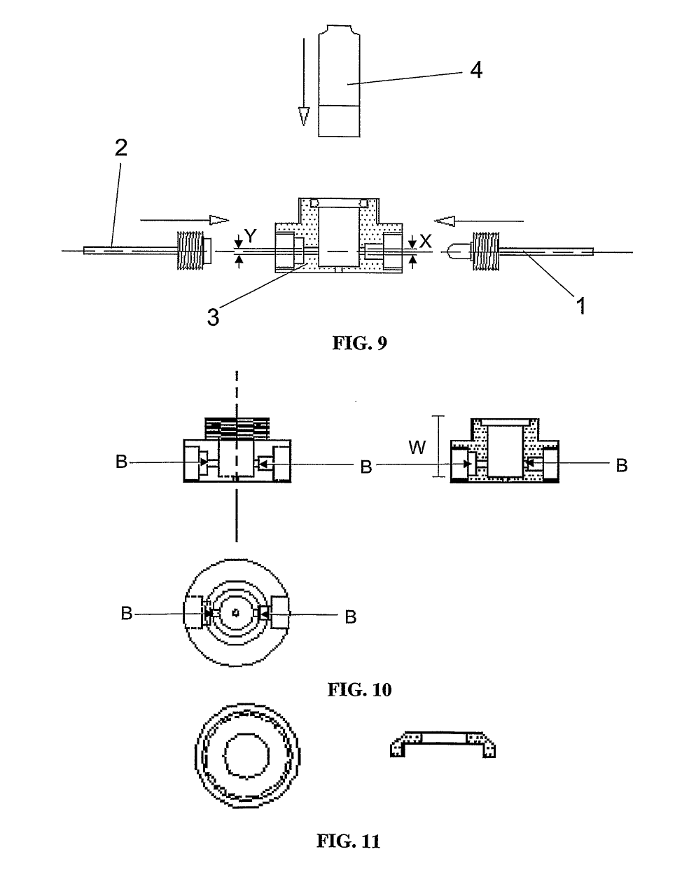

FIG. 9 shows the equipment optical system. The LED and the Photosensor tunnels diameter (X and Y, respectively), is between 0.2 mm and 5 mm, preferably between 1 mm and 3 mm, and more preferably at 2 mm. This measure has been empirically obtained from assays, with the purpose of reducing both the light beam distortion, caused by the ampoule/cuvette walls curved geometry, and the spurious light detection from the upper portion of the sample holder cavity.

The LED tunnel (B), 1.8 mm long, makes the collimation for the light beam emitted by the LED, focusing it on the photosensor tunnel (B) opening, which is 4.55 mm long (FIG. 10).

The distance W from the tunnels center up to the sample holder upper edge, 17 mm long, has been established in such a way to minimize the spurious light interference. The whole set is closed by a cover.

The signal generated by the sensor is processed in an electronic circuit based on a chip with 4 operational amplifiers, supplied by a simple source. The circuit is supplied by a 9-volt rechargeable battery connected to a regulator (FIG. 8).

The signal from the analogical electronics gets in the PIC family microprocessor through a port defined as digital analogical converter. The calculations are performed in the microprocessor, and the hemoglobin concentration result, in grams by deciliter (g/dL), is shown on the liquid crystal display (FIG. 8).

The device for determining the hemoglobin concentration in a diluted blood sample in the present invention comprises a cylindrical ampoule-cuvette (4), which is simultaneously a device for filling the system reagent and optical component (cuvette), allowing photometric reading through its walls, composed of any material with optical, chemical and mechanical features allowing their use, such as: polymers or neutral glass or borosilicate.

The ampoule-cuvette (4) diameter is between 8 and 20 mm, preferably between 10 and 13 mm, and more preferably, at 12.9 mm.

1. A process for in vitro, one-step determination of hemoglobin concentration in a diluted blood sample, comprising the steps of:
a) establishing an absorbance function by using a light intensity measurement inside an empty sample holder, as: Absorbance (X) is equivalent to Log 10 (empty sample holder light intensity/X light intensity);
b) introducing constants obtained experimentally by means of mean absorbance measurements of blank sample C1 and standard sample C2 are introduced in the processing, so as to obtain the hemoglobin concentration of a certain sample in a single manual step, by measuring the light intensity in a sensor with the sample positioned inside a bottle, which is simultaneously the reagent package and an optical component;
c) automatically obtaining the light intensity in the sensor with the empty sample holder, required for the calculation, at the beginning of the measurement process; and
d) calculating the hemoglobin concentration in the sample as: 10*[Ab(T)−C1]/C2.

2. The process as claimed in claim 1, wherein the sample is introduced in the bottle, and photometric readings are taken through walls of the bottle.

3. The process as claimed in claim 1, wherein the photometric measurements are performed between 500 and 550 nm.

4. The process as claimed in claim 3, wherein the photometric measurements are performed between 520 and 540 nm.

5. The process as claimed in claim 3, wherein the photometric measurements are performed at 525 nm.

6. The process as claimed in claim 1, wherein the diluent is composed of a hemolizing solution.

7. The process as claimed in claim 6, wherein the hemolizing solution is a Modified Drabkin Solution.

8. The process as claimed in claim 6, wherein the hemolizing solution is deionized distilled water, at a proportion higher than or equal to 300:1.

9. A device for determining hemoglobin concentration in a diluted blood sample, comprising:
a) a light source (1) whose wavelength is between 500 and 550 nm;
b) a cylindrical sample holder (3), whose diameter is between 8 and 20 mm;
c) a photosensor (2) for performing sample photometry; and
d) microprocessor for automatically starting the light source, acquiring the signal obtained by the photosensor (2), performing the hemoglobin concentration calculations and displaying the results in a liquid crystal display.

10. The device as claimed in claim 9, wherein the light source (1) is composed of a LED.

11. The device as claimed in claim 9, wherein the light source (1) wavelength is between 520 and 540 nm.

12. The device as claimed in claim 9, wherein the light source (1) wavelength is 525 nm.

13. The device as claimed in claim 9, wherein the cylindrical sample holder (3) has a diameter is between 10 and 13 mm.

14. The device as claimed in claim 9, wherein the cylindrical sample holder (3) has a diameter of 12.9 mm.

15. The device as claimed in claim 9, wherein the light emitted by the light source (1) and received by the sensor (2) is collimated, through cylindrical tunnels with a diameter between 0.2 mm and 5 mm.

16. The device as claimed in claim 15, wherein the cylindrical tunnels have a diameter between 1 mm and 3 mm.

17. The device as claimed in claim 15, wherein the cylindrical tunnels have a diameter of 2 mm.

18. A device for determining hemoglobin concentration in a diluted blood sample, comprising a sealed cylindrical reagent bottle, which is simultaneously used as a package for a reagent and as an optical component in a process for determining hemoglobin concentration in a diluted blood sample, wherein the reagent bottle allows for photometric reading through the walls of the reagent bottle.

19. The device as claimed in claim 18, wherein the reagent bottle has an optical path between 8 and 20 mm.

20. The device as claimed in claim 19, wherein the optical path of the reagent bottle is between 10 and 14 mm.

21. The device as claimed in claim 19, wherein the optical path of the reagent bottle is 12.9 mm.

22. The device as claimed in claim 18, wherein the reagent bottle is composed of any material with optical quality enough to allow photometric reading.

23. The device as claimed in claim 22, wherein the reagent bottle is made of a polymer.

24. The device as claimed in claim 22, wherein the reagent bottle is composed of neutral glass or borosilicate.
